(19) United States
(12) Patent Application Publication
(10) Pub. No.: US 2009/0097197 A1
(43) Pub. Date: Apr. 16, 2009

(54) SIDE PLATE OF HOUSING

(76) Inventor: Ming-Chu Chen, Chung-Ho City (TW)

Correspondence Address: HDLS Patent & Trademark Services, P.O. BOX 220746, CHANTILLY, VA, 20153-0746, US

(21) Appl. No.: 11/870,500

(22) Filed: Oct. 11, 2007

(51) Int. Cl. G06F 1/20

(52) U.S. Cl. 361/679.46

(57) ABSTRACT

A side plate that allows the locations of heat-dissipating holes to be arranged includes a plate, a plurality of sealed sealing blocks and a plurality of air-hole blocks having air holes. The plate is provided with a through hole occupying a considerable area thereof and a plurality of sliding rails that are arranged at intervals to straddle on the through hole. Each of the sealing blocks and each of the air-hole blocks have substantially the same size and the same shape. Two adjacent sliding rails have a predetermined pitch therebetween to accommodate the air-hole blocks or the sealing blocks, whereby the air-hole blocks and the sealing blocks are arranged in array fashion to cover the through hole.

### BACKGROUND OF THE INVENTION

1. Field of the Invention

The present invention relates to a computer, and in particular to a housing of a computer host. Especially, the present invention relates to a side plate of a housing which has heat-dissipating holes.

2. Description of Prior Art

With the progress of science and technology, the computer can perform a rapid operation and store a large amount of data, so that it has become a necessity for people in daily life and work. Further, since the heat generated by hard disk, optical disk, power supply, processing chip and various components in the computer has already increased to a serious extent, the heat is accumulated in the computer housing significantly.

Although the existing computer housing is provided at a side plate or rear plate thereof with heat-dissipating holes, so that the airflow inside or outside the housing can flow through these heat-dissipating holes, such kind of heat-dissipating holes are usually set after being manufactured completely and cannot be adjusted according to the later arrangement of the components in the computer. Especially, the side plate of the computer housing is located at the side corresponding to the most important element in the computer (i.e. CPU). In addition, a VGA card that the heat generated needs to be dissipated is also positioned at the same side as the side plate of the computer housing. Therefore, if the heat-dissipating holes on the side plate cannot be adjusted to match the arrangement of various components in the computer, the heat-dissipating holes on the side plate cannot exhibit a better effect.

Therefore, in view of this, the inventor proposes the present invention to overcome the above problems based on his expert experience and deliberate research.

### SUMMARY OF THE INVENTION

The present invention is to provide a side plate of a housing, which utilizes small-sized and modulized rectangular flat blocks to be arranged in array fashion to cover a through hole of the side plate of the computer housing. Further, with air holes preset on each flat block, the flat blocks having air holes are arranged on the side plate at desired positions that need to be ventilated. On the other hand, the sealed flat blocks are arranged on the side plate at remaining positions that need not to be ventilated. In this way, according to the arrangement of various components in the computer, the positions of the flat blocks having air holes can be adjusted.

The present invention is to provide a side plate of a housing, which includes a plate, a plurality of sealed sealing blocks and a plurality of air-hole blocks having air holes. The plate is provided with a through hole occupying considerable area thereof and a plurality of sliding rails that are arranged at intervals to straddle on the through hole. Each of the sealing blocks and each of the air-hole blocks have substantially the same size and the same shape. Two adjacent sliding rails have a predetermined pitch therebetween to accommodate the air-hole blocks or the sealing blocks, whereby the air-hole blocks and the sealing blocks are arranged in array fashion to cover the through hole. Via the arrangement of the array of each sealing block and air-hole block, the above purposes can be achieved.

### BRIEF DESCRIPTION OF THE DRAWINGS

FIG. 1 is an exploded perspective view showing the present invention and a computer housing;

FIG. 2 is an exploded perspective view of the present invention;

FIG. 3 is an enlarged view showing the details of portion A in FIG. 2.

FIG. 4 is an assembled perspective view of the present invention;

FIG. 5 is a perspective view showing another arrangement of the present invention;

FIG. 6 is a perspective view showing a further arrangement of the present invention; and

FIG. 7 is a plan view showing another arrangement of the present invention.

### DETAILED DESCRIPTION OF THE INVENTION

In order to make the Examiner to better understand the characteristics and technical contents of the present invention, a detailed description will be made with reference to the accompanying drawings. However, it should be understood that the drawings are illustrative only but not to limit the scope of the present invention.

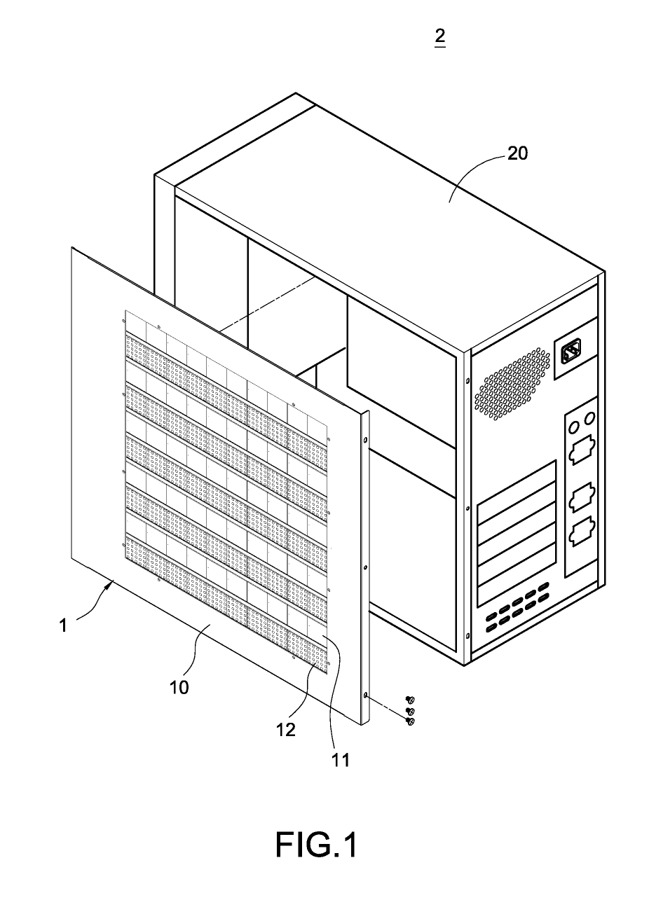

With reference to FIG. 1, it is an exploded perspective view showing the present invention and a computer housing. The present invention provides a side plate of a housing. The side plate 1 is provided on the left or right side of a casing 20 of a computer housing 2, thereby shielding the components (not shown) in the computer housing 2. In this way, the invasion of dust or foreign matters can be avoided, thereby generating protective and aesthetic effects.

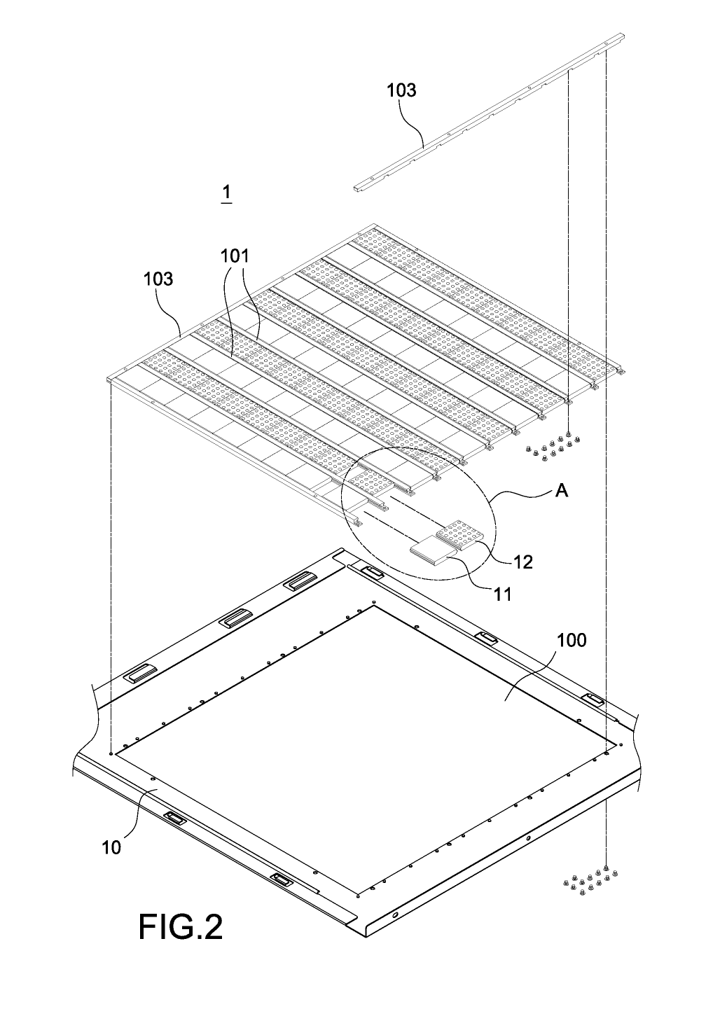

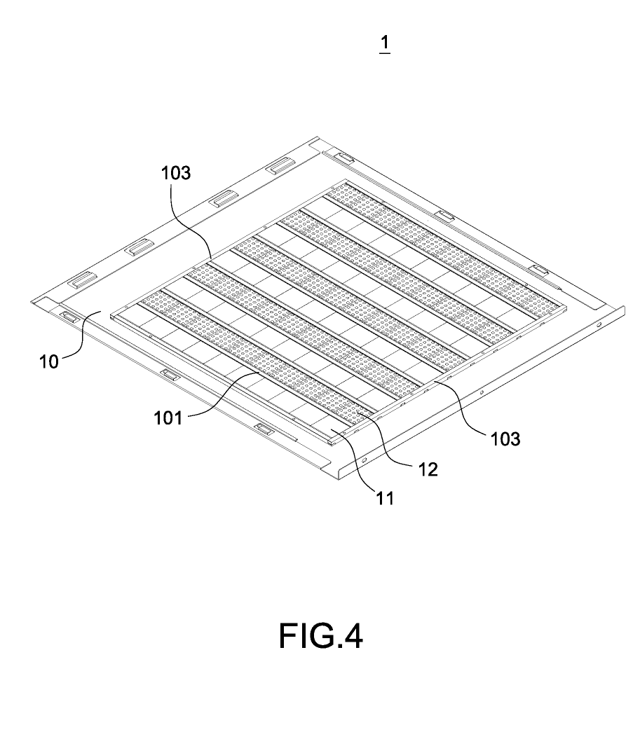

With reference to FIGS. 2 and 4, the side plate 1 includes a plate 10, a plurality of sealing blocks 11 and air-hole blocks 12 that are formed into rectangular flat blocks. The plate 10 is provided with a rectangular through hole 100 occupying a considerable area thereof. The through hole 100 is provided thereon with a plurality of strip-like sliding rails 101 that straddle on the through hole and are arranged at intervals in parallel to one another along the same direction. Two adjacent sliding rails have a predetermined pitch therebetween to accommodate the air-hole blocks or the sealing blocks, whereby the air-hole blocks and the sealing blocks are arranged in array fashion to cover the through hole.

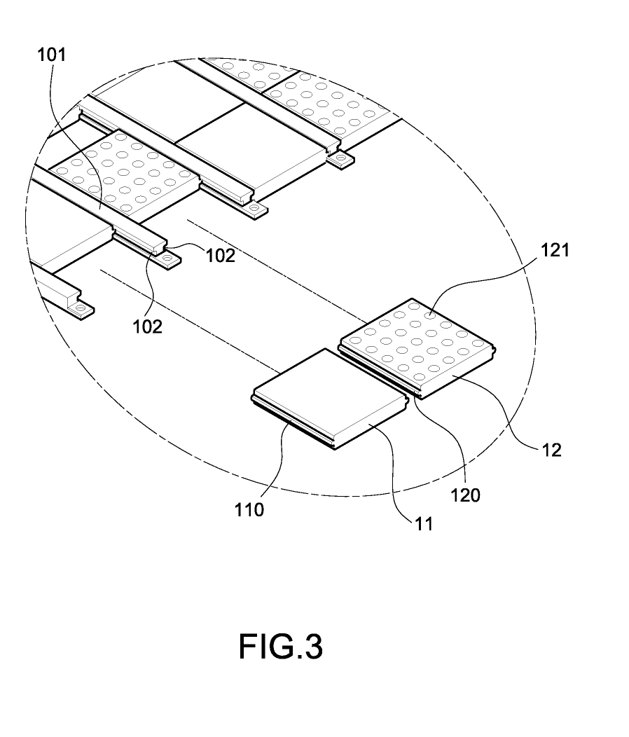

As shown in FIG. 3, in the illustrated embodiment of the present invention, each of the sliding rails 101 comprises two grooves 102 defined on two lateral sides thereof, respectively, and extended along a lengthwise direction of the sliding rail 101. Each of the sealing blocks 11 or air-hole blocks 12 comprises two protruding ribs 110, 120 provided on two opposite lateral faces, respectively. The protruding rib 110, 120 can be slidably fit into the groove 102 of the sliding rail 101, so that any one of the sealing block 11 or air-hole block 12 can slid into any two adjacent sliding rails 101 via the protruding ribs 110, 120 on both sides thereof, thereby forming an array. In addition, the positions of the sliding rail 101 and the protruding ribs 110, 120 can be changed with each other.

With reference to FIG. 2, after each sealing block 11 or air-hole block 12 is disposed between any two adjacent sliding rails 101 to fill on the through hole 100, on both sides of the through hole 100 in another vertical direction, two frame strips 103 can be arranged to block on the plate 10, thereby preventing the sealing blocks 11 or air-hole blocks 12 provided between the sliding rails 101 from dropping out.

With reference to FIG. 4, the present invention utilizes modulized sealing blocks 11 and air-hole blocks 12 and the arrangement of each sliding rail 101 at intervals to arrange the sealing blocks 11 or air-hole blocks 12 in array fashion to cover the through hole 100 of the plate 10. The difference between the sealing block 11 and the air-hole block 12 lies in that the air-hole block 12 has a plurality of air holes 121 that allow airflow to flow through while the sealing block 11 is solid and sealed. The shape and size of the air-hole block is identical to those of the sealing block. Via the arrangement of the array of the sealing blocks 11 and air-hole blocks 12, the user can arrange the positions of each sealing block 11 and air-hole block 12 arbitrarily according to his demand. Therefore, the air-hole blocks 12 having air holes 121 can be arranged on the positions corresponding to those of the high heat-generating components in the computer. In this way, the heat generated by these high heat-generating components can be dissipated to the outside of the computer housing.

Therefore, with the combination of the above components, the side plate of the housing of the present invention can be achieved.

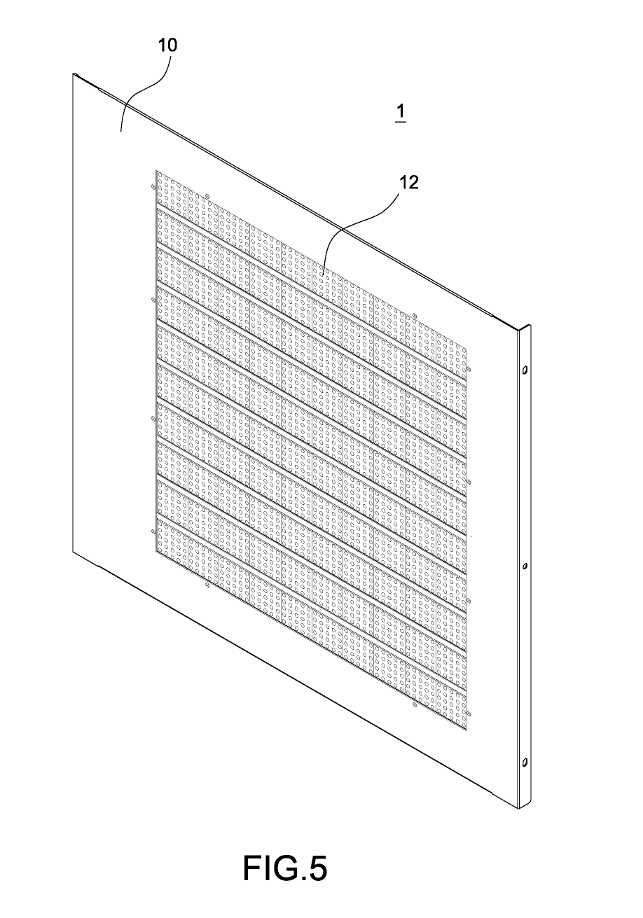

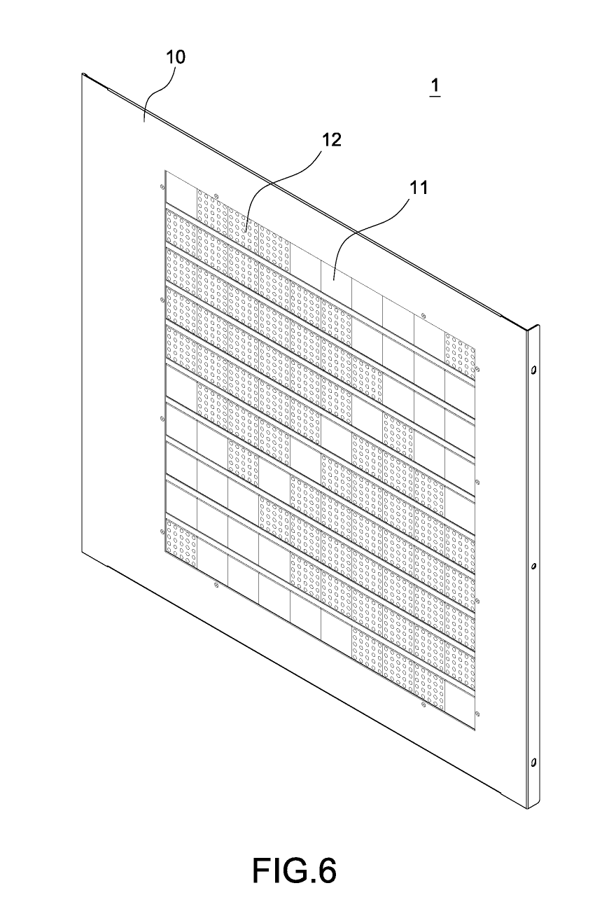

Via the side plate of the housing of the present invention, the positions of the air holes 121 can be changed according to the locations of heat-generating elements in the computer. As shown in FIG. 5, the user can choose to use all the air-hole blocks 12, so that the through hole 100 on the side plate 1 is covered by the air-hole blocks 12. Further, as shown in FIG. 6, if it is unnecessary to consider the ventilation, the user can generate different arrangements based on his demand.

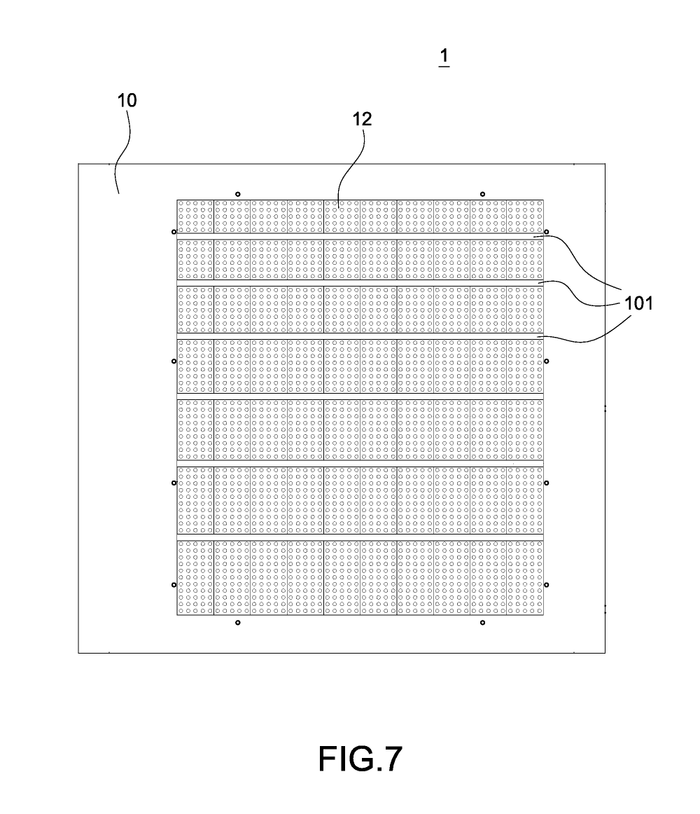

Further, as shown in FIG. 7, it is a plan view showing another embodiment of the present invention. The pitch between adjacent sliding rails 101 can be designed to be different. For example, the pitch between any two sliding rails 101 can be designed to increase from top to bottom. As a result, the shape and size of each sealing block 11 and air-hole block 12 should be adjusted to correspond to the pitches and locations of the associated sliding rails 101.

According to the above, the present invention can solve the drawbacks of prior art and achieve the expected purposes. Further, it indeed involves novelty and inventive steps and thus conforms to the requirements for a utility model patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A side plate of a housing, comprising:
a plate comprising a through hole defined thereon and a plurality of sliding rails arranged across the through hole in straddling manner, wherein the through hole occupies a considerable area of the plate;
a plurality of sealing blocks; and
a plurality of air-hole blocks, each of the air-hole blocks having air holes defined thereon, wherein each of the air-hole blocks and each of the sealing blocks have substantially the same size and the same shape;
wherein two adjacent sliding rails have a predetermined pitch therebetween to accommodate the air-hole blocks or the sealing blocks, whereby the air-hole blocks and the sealing blocks are arranged in array fashion to cover the through hole.

2. The side plate of a housing according to claim 1, wherein the pitch between two adjacent sliding rails is identical.

3. The side plate of a housing according to claim 1, wherein each of the sliding rails comprises two grooves defined on two lateral sides thereof, respectively, and extended along a lengthwise direction of the sliding rail; each of the sealing blocks comprises two protruding ribs provided on two opposite lateral faces, respectively, wherein the protruding rib is slidably fit into the groove.

4. The side plate of a housing according to claim 1, wherein each of the sliding rails comprises two grooves defined on two lateral sides thereof, respectively, and extended along a lengthwise direction of the sliding rail; each of the air-hole blocks comprises two protruding ribs provided on two opposite lateral faces, respectively, wherein the protruding rib is slidably fit into the groove.

5. The side plate of a housing according to claim 1, wherein each of the sliding rails comprises protruding ribs provided on two lateral sides thereof, respectively, and extended along a lengthwise direction of the sliding rail; each of the sealing blocks comprises two grooves defined on two opposite lateral faces, respectively, wherein the protruding rib is slidably fit into the groove.

6. The side plate of a housing according to claim 1, wherein each of the sliding rails comprises protruding ribs provided on two lateral sides thereof, respectively, and extended along a lengthwise direction of the sliding rail; each of the air-hole block comprises two grooves defined on two opposite lateral faces, respectively, wherein the protruding rib is slidably fit into the groove.

7. The side plate of a housing according to claim 1, further comprising two frame strips provided on the plate and to seal ends of the sliding rails, whereby the sealing block and the air-hole block accommodated in the sliding rails are prevented from dropping out.
